(19) United States
(12) Patent Application Publication
(10) Pub. No.: US 2018/0222104 A1
(43) Pub. Date: Aug. 9, 2018

(54) METHOD FOR MANUFACTURING SYNTHETIC RESIN SCOURING PAD

(71) Applicant: KWANG JIN IND. CO., LTD., Gyeongsangbuk-do (KR)

(72) Inventors: Hyeong-Cheol HWANG, Gyeongsangbuk-do (KR); Kang-Sik CHO, Gyeongsangbuk-do (KR); Dae-Hwan KIM, Gyeongsangbuk-do (KR); Heon-Joo JEONG, Daegu (KR)

(73) Assignee: KWANG JIN IND. CO., LTD., Gyeongsangbuk-do (KR)

(21) Appl. No.: 15/748,038

(22) PCT Filed: Sep. 14, 2015
(86) PCT No.: PCT/KR2015/009597

§ 371 Date: Jan. 26, 2018

(30) Foreign Application Priority Data
Jul. 28, 2015 (KR) 10-2015-0106396

(51) Int. Cl. B29C 47/00; B29C 53/32; B29C 53/56; B29C 47/88; A47L 17/08

(52) U.S. Cl. CPC B29C 47/0059; B29C 47/0066; B29C 47/0021; B29K 2067/003; B29C 53/564; B29C 47/8895; A47L 17/08; B29C 53/32

(57) ABSTRACT

A method for manufacturing a synthetic resin scouring pad includes hot extruding a polymer by thermally melting a synthetic resin, along a T die having a straight extrusion port, to form a full width film sheet; cold-curing the film sheet by impregnating and quenching the extruded full width film sheet with cooling water of a cooling bath; forming flat film filaments by passing the full width film sheet lengthwise through a cutting part in which cutting blades are arranged at a predetermined width so as to dividingly-cut the full width film sheet into a predetermined width; passing the flat film filaments in the longitudinal direction through a coiling forming part to plastic-deform the flat film filaments into coil-shaped film filaments; and inputting the coil-shaped film filaments into an annular winding part so that the film filaments are wound in an annular shape to form a synthetic resin scouring pad.

### FIELD

The present invention relates to a method of manufacturing a synthetic resin scouring pad, and more specifically, to a method of manufacturing a synthetic resin scouring pad which has cleaning performance comparable to that of a steel scouring pad and can solve various problems that the steel scouring pad has so as to replace the existing steel scouring pad.

### BACKGROUND

Generally, a scouring pad is mainly used for washing utensils, cutlery, gas ranges, household appliances and the like in the kitchen, and also may be used and applied for bathtubs, sinks, toilets, tiles and the like, and has a wide scope of application.

Conventionally, various types of synthetic resin scouring pads such as net-type synthetic resin scouring pads formed by weaving synthetic yarn in a net structure, foam-filled type synthetic resin scouring pads formed by filling a net woven with synthetic yarn with a sponge and the like have been widely used. Such synthetic resin scouring pads cause a small degree of damage to the surface of an object to be cleaned and generate a large amount of bubbles by the introduction of a small amount of detergent so that soft contaminants are easily removed.

However, it is difficult to use the synthetic resin scouring pad for objects to be cleaned such as pots or grill pans to which contaminants are severely attached since the synthetic resin scouring pad has low cleaning power unlike a steel scouring pad. Further, contaminants removed from the object to be cleaned may penetrate into the fibrous tissue and cause secondary contamination of the scouring pad.

Accordingly, when the object to be cleaned such as a grill pan or the like is cleaned, a steel scouring pad formed of metal threads such as stainless steel is used to stably clean foreign matter adhered to the surface of the object to be cleaned such as a grill pan or a pot by repetitive friction with metal threads.

Since the metal threads forming the steel scouring pad have high hardness, when the surface of the object to be cleaned such as a cooking utensil or the like is strongly rubbed by a user, the surface of the object to be cleaned is scraped by the metal threads so that foreign matter adhered to the surface may be quickly and stably removed.

However, the steel scouring pad is formed of the metal threads having high hardness, and thus frequently causes damage to the surface or coating film of the object to be cleaned. In addition, metal fine powder generated due to friction grinding of the metal threads and metal fragments cut from metal filaments during a cleaning process remain on the surface of the object to be cleaned.

Of course, such metal fine powder generated due to friction grinding of the metal threads and the metal fragments cut from the metal filaments may be removed by cleaning with cleaning water.

However, when cleaning with cleansing water is unstably performed, metal fine powder or metal fragments may remain on the surface of cutlery or cooking containers, and the residual metal fine powder or metal fragments may be mixed into the food. Therefore, it is not desirable in terms of food hygiene and safety.

Accordingly, in the related field, there is a need for the development and promotion of a new type of a scouring pad which has excellent cleaning power like the steel scouring pad, minimizes the surface damage of the object to be cleaned, and especially, does not generate harmful matter such as metal fine powder and metal fragments harmful to the human body during the cleaning process.

### SUMMARY

In view of the above-mentioned demands, an objective of the present invention is to provide a method of manufacturing a synthetic resin scouring pad which has cleaning performance comparable to that of the steel scouring pad and can solve various problems that the steel scouring pad has so as to replace the existing steel scouring pad.

The above-described object is achieved by the following configuration provided in the present invention.

A method of manufacturing a synthetic resin scouring pad according to the present invention includes: a hot extrusion step of extruding a polymer, which is formed by thermally melting a synthetic resin, along a T die having a straight extrusion port, to form a full width film sheet; a cold curing step of cold-curing the film sheet by impregnating and quenching the extruded full width film sheet with cooling water of a cooling bath; a cutting step of forming flat film filaments by passing the full width film sheet lengthwise through a cutting part in which cutting blades are arranged at a predetermined width so as to dividingly-cut the full width film sheet into a predetermined width; a coiling forming step of passing the flat film filaments, formed by the cutting step, in the longitudinal direction through a coiling forming part to plastic-deform the flat film filaments into coil-shaped film filaments; and an annular winding step of inputting the coil-shaped film filaments into an annular winding part so that the film filaments are wound in an annular shape to form a synthetic resin scouring pad.

Preferably, the synthetic resin forming the film sheet and the film filament may be formed of any one of a polyethylene terephthalate (PET) resin and a polyethylene naphthalate (PEN) resin.

More preferably, the coiling forming part may include: a supply roller part; a discharge roller part; and a coiling guide disposed between the roller parts.

Further, in the hot extrusion step, the synthetic resin may be mixed with an antibacterial additive and a color additive.

As described above, according to the present invention, there is proposed a synthetic resin scouring pad formed by winding film filaments, which are prepared by thin-cutting a film sheet formed by hot extrusion into a predetermined width, in an annular shape.

It was confirmed that the film filaments forming the synthetic resin scouring pad has stable bubble generation performance and stable washing performance with respect to an object to be cleaned by friction, and has cleaning power which is 6 to 17% lower compared to an existing iron scouring pad, but is 29% higher or more compared to a sponge scouring pad.

Particularly, in the present invention, in forming a synthetic resin scouring pad by winding the film filaments in an annular shape, the film filaments are coiled through a coiling process so that each sharp edge formed at two ends of the film filament is exposed to the outside, thereby enabling more stable cleaning of an object to be cleaned by scraping action of each of the sharp edge.

Moreover, the film filaments have excellent toughness and low brittleness compared to metal filaments, and thus can resolve general problems that the existing steel scouring pads have, that is, such as problems in which the metal filaments are worn out due to friction with an object to be cleaned, and a large amount of metal powder is generated or metal fragments cut from the metal filaments remain on the surface of the object to be cleaned, and thus is preferable in terms of food safety.

Further, in the present invention, a series of steps for manufacturing a synthetic resin scouring pad including a hot extrusion step using a hot extruder, a cold curing step, a cutting step, a coiling step and a winding step can be automatically performed, thereby enabling mass production.

### BRIEF DESCRIPTION OF THE DRAWINGS

FIG. 1 shows an appearance of a synthetic resin scouring pad formed by a method of manufacturing a synthetic resin scouring pad according to the present invention.

FIG. 2 schematically shows an overall forming process of a synthetic resin scouring pad through a method of manufacturing a synthetic resin scouring pad according to the present invention.

FIG. 3 shows a forming state of film filaments and a cross-section of the film filaments formed through a method of manufacturing a synthetic resin scouring pad according to the present invention.

FIG. 4 shows the optimum specifications of a synthetic resin scouring pad manufactured according to the present invention.

FIG. 5 shows an experiment on the bubble generation performance of a synthetic resin scouring pad formed according to the present invention.

FIG. 6 is a photograph showing a comparison between the appearances of a scouring pad manufactured according to a method of the present invention and an existing scouring pad.

FIG. 7 shows a comparison of cleaning performance between synthetic resin scouring pads formed according to the present invention.

### DETAILED DESCRIPTION

Hereinafter, a preferred embodiment of a method of manufacturing a synthetic resin scouring pad according to the present invention will be described in detail with reference to the accompanying drawings.

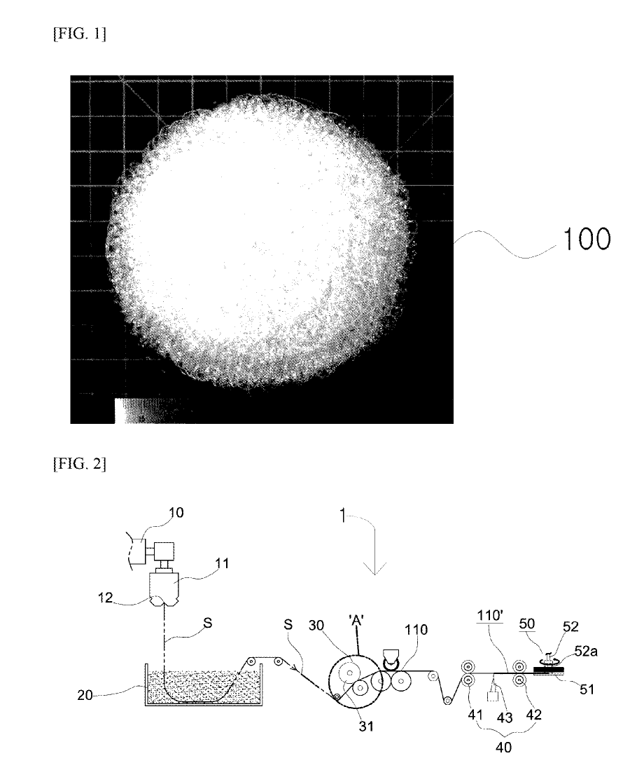

FIG. 1 shows an appearance of a synthetic resin scouring pad formed by a method of manufacturing a synthetic resin scouring pad according to the present invention.

As shown in FIG. 1, a synthetic resin scouring pad 100 formed by the present invention is a cleaning product manufactured by winding film filaments 110 and 110′ formed of a synthetic resin material in an annular shape. When a user grasps the synthetic resin scouring pad 100 and rubs the surface of an object to be cleaned, foreign matter adhered on the surface of the object to be cleaned is scraped off by surface friction with each of the film filaments 110 and 110′ forming the synthetic resin scouring pad 100 and removed.

Further, in the present invention, the film filaments are not formed in a flat shape, but are formed in a coiled shape, in which the film filaments are coiled in a spiral shape so that both edge portions stand and are exposed, and thus the synthetic resin scouring pad 100 including the film filaments has a three-dimensional volume. Accordingly, the synthetic resin scouring pad 100 is easy to grip and has bubble generation performance, and enables stable cleaning of the object to be cleaned through both of the exposed edge portions.

Particularly, in the present invention, since coil-shaped film filaments 110 and 110′ forming the synthetic resin scouring pad 100 through the annular winding are formed of a synthetic resin which is harmless to the human body and has sufficient strength for washing, sufficient cleaning is possible without generating metal fine powder or metal fragments during a cleaning process.

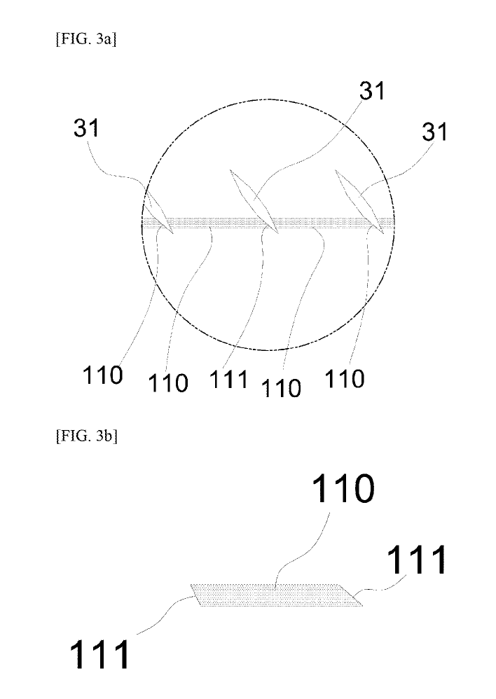

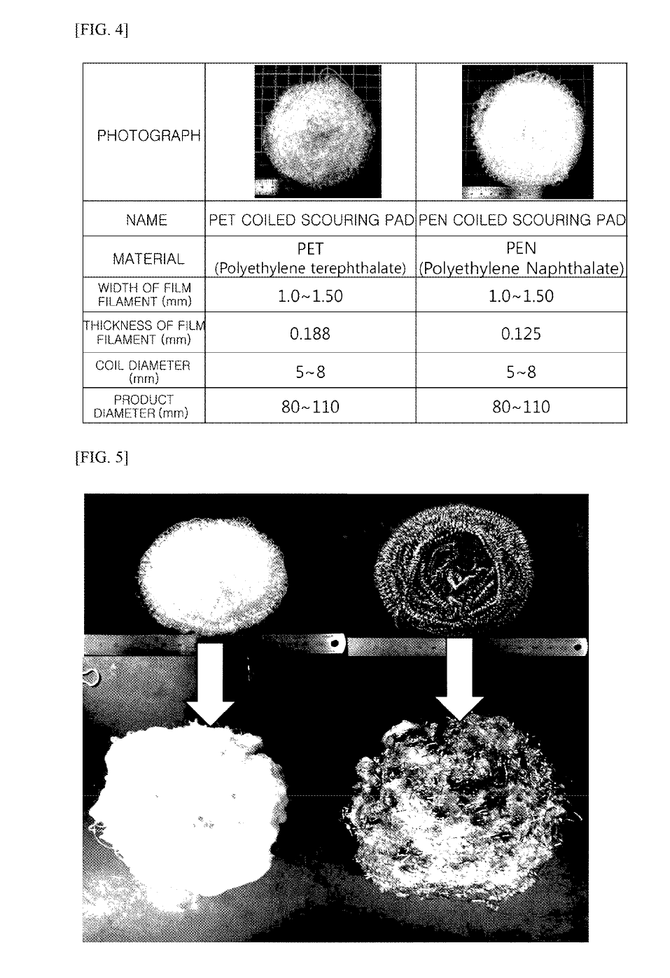

FIG. 2 schematically shows an overall forming process of a synthetic resin scouring pad through the method of manufacturing a synthetic resin scouring pad according to the present invention, FIGS. 3A and 3B show a forming state of film filaments and a cross-section of film filaments formed through the method of manufacturing the synthetic resin scouring pad according to the present invention, and FIG. 4 shows the optimum specifications of the synthetic resin scouring pad manufactured according to the present invention.

Further, as shown in FIG. 2, a manufacturing device 1 for manufacturing the synthetic resin scouring pad according to the present invention includes: an extruder 10 for forming a film sheet S having a predetermined thickness by melting a synthetic resin; a cooling tank 20 for quenching the film sheet S extruded through the extruder 10 to solidify the film sheet S; a cutting part 30 for forming flat film filaments 110 cut into a predetermined width by cutting the film sheet S solidified by the quenching into a predetermined width; a coiling forming part 40 for forming coil-shaped film filaments 110′ by continuously coiling-forming the flat film filaments 110 cut into a predetermined width through the cutting part; and an annular winding part 50 for annularly winding the coil-shaped film filaments 110′ formed through the coiling forming part 40.

Hereinafter, a method of manufacturing a synthetic resin scouring pad according to the present invention using the manufacturing device 1 will be described in detail with reference to FIGS. 2 to 3.

### Step of Forming Film Sheet

In the present step, a synthetic resin in the form of a chip is input into the extruder 10 to be hot-melted, and the hot-melted polymer P is extruded through a straight extrusion port 12 of a T die 11 to form the film sheet S having a predetermined thickness.

Examples of the chip-shaped synthetic resin to be formed into a full-width film sheet S by the hot extrusion may include various synthetic resins such as a PE resin, a PP resin and the like, but a polyethylene terephthalate (PET) resin and a polyethylene naphthalate (PEN) resin, which are known to have excellent hardness, heat resistance and abrasion resistance, and is harmless to the human body, are most preferably used.

Further, in the present embodiment, in adopting the PET resin or the PEN resin, a full-width film sheet S having a predetermined thickness of 0.1 to 0.35 mm is formed through a hot extrusion step.

### Cold Curing Step

Thereafter, the hot-extruded film sheet S is input into the cooling tank 20 disposed at the lower part of the T die 11, is passed in a state of being impregnated with cooling water and quenched to be cold-cured. The cold-cured full-width film sheet S is moved in the longitudinal direction and input into the cutting part 30.

### Cutting Step

The cold-cured full-width film sheet S is cut into a predetermined width while passing through the cutting part 30 to form flat film filaments 110 of which both edges are sharp.

The cold-cured flat film sheet 110 is cut by each of the cutting blades 31 in the longitudinal direction while passing through the cutting part 30 in which the cutting blades 31 are arranged at a predetermined width to form the flat film filaments 110 cut into a predetermined width.

Here, as shown in FIG. 3, the cutting blades 31 for cutting the film sheet S in the longitudinal direction are formed of an annular disk and are obliquely disposed so that oblique blade portions 111 are formed at both edges of the flat film filaments 110 cut by the cutting blades 31.

Further, in the present embodiment, the cutting blades 31 are configured as hot-cutting blades that are slotted into the film sheet S in a high-temperature heated state and hot-cuts the film sheet S, so that finer oblique blade portions 111 are formed by hot cutting.

Further, in the present embodiment, a full-width film sheet S having a predetermined thickness of 0.1 to 0.35 mm by the hot extrusion step is cut into a predetermined width of 0.5 to 0.25 mm by the cutting step to form the flat film filaments 110.

It was confirmed that the flat film filaments 110 having the predetermined thickness and predetermined width may realize stable coiling forming in a coiling forming step which will be described below, and the synthetic resin scouring pad 100 formed through the coiling forming step and an annular winding step has excellent cleaning power and bubble generation performance.

The flat film filaments 110 formed through the hot extrusion step, the cooling step, and the cutting step may be continuously input into the coiling forming part 40 and the annular winding part 50 so that the coiling forming step and the annular winding step may be carried out continuously.

However, the flat film filaments 110 are wound on respective bobbins and sequentially input into the coiling forming part 40 and the annular winding part 50 to perform the coiling forming step and the annular winding step, and thereby a synthetic resin scouring pad in which coil-shaped film filaments are annularly wound may be formed.

### Coiling Forming Step

The coiling forming part 40 performing the coiling forming step includes: a supply roller part 41 for supplying the flat film filaments 110; a coiling guide 43 for coiling the flat film filaments 110 moving in the longitudinal direction along the supply roller part 41; and a discharge roller portion 42 for discharging the coil-shaped film filaments 110′ coiled as above. The flat film filaments 110 moving in the longitudinal direction along the supply roller part 41 and the discharge roller part 42 are plastically deformed into a coil shape by the slotted coiling guide 43 to form coil-shaped film filaments 110′.

Here, when the supply roller part 41 is configured as a hot supply roller part capable of preheating the flat film filaments 110, and the discharge roller part 42 is configured as a cold discharge roller part for cooling the coiled coil-shaped film filaments 110′, more stable coiling of the flat film filaments and solidification of the shape of the coiled coil-shaped film filaments 110′ are possible.

### Annular Winding Step

The coil-shaped film filaments 110′ plastically deformed into a coil shape through the coiling forming step are input into the annular winding part 50 to form a synthetic resin scouring pad 100 in which the coil-shaped film filaments 110′f are annularly wound.

According to the present embodiment, the annular winding part 50 for winding the coil-shaped film filaments 110′ has a form in which a winding shaft 52 having a branched-type fastening member 52a disposed at the tip thereof is disposed at the upper portion of a base 51. The coil-shaped film filaments 110′ fastened to the fastening member 52a by the unidirectional rotation of the winding shaft 52 are annularly wound in one direction to form the synthetic resin scouring pad 100.

Further, as necessary, the annular wound synthetic resin scouring pad 100 may be input into a hot chamber having a temperature of 100 to 200° C. for 3 to 10 minutes to thermally shrink the coil-shaped film filaments 110′ and stabilize the texture of the coil-shaped film filaments 110′, which is also within the scope of the present invention.

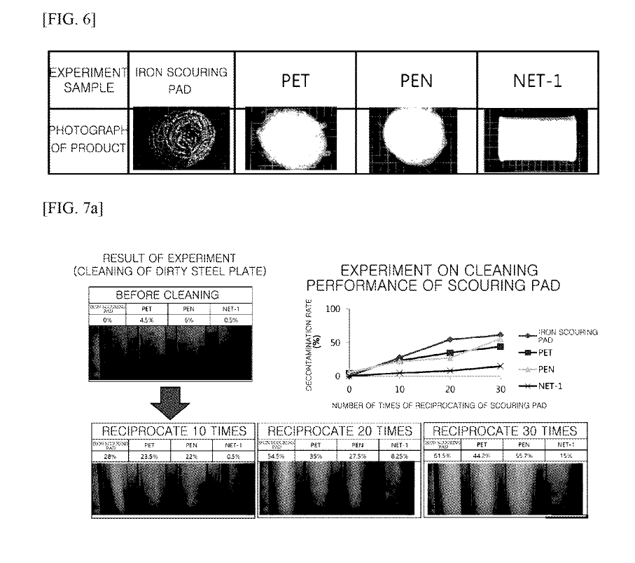

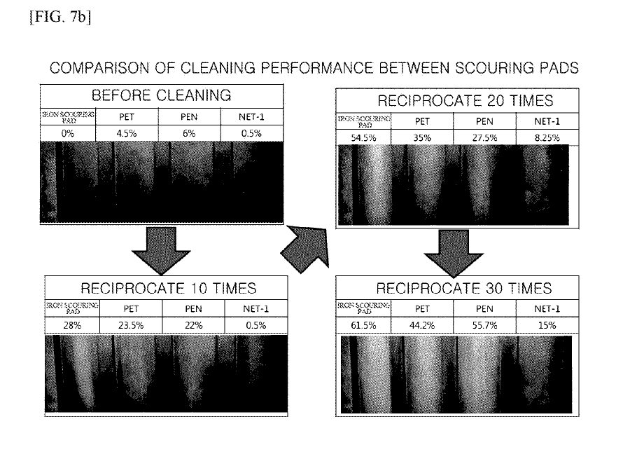

Further, FIG. 4 shows the optimum specifications of the synthetic resin scouring pad manufactured according to the present invention, FIG. 5 shows an experiment on the bubble generation performance of the synthetic resin scouring pad formed according to the present invention, FIG. 6 is a photograph showing a comparison between the appearances of a scouring pad manufactured according to the method of the present invention and an existing scouring pad, and FIG. 7 shows a comparison of cleaning performance between synthetic resin scouring pads formed according to the present invention. Hereinafter, the bubble generation performance and cleaning performance of the synthetic resin scouring pad according to the present invention will be described in detail with reference to these drawings.

Hereinafter, an experiment is performed in which the performance of the synthetic resin scouring pad according to the present invention, which is manufactured with the optimum specifications as shown in FIG. 4, is compared with an existing steel scouring pad and a woven synthetic resin scouring pad as control groups.

### Bubble Generation Performance Experiment

First, the experimental conditions of the bubble generation performance were as follows: a process, in which a steel scouring pad and a synthetic resin scouring pad manufactured by the method of the present invention were impregnated in 1000 ml of tap water at room temperature and dehydrated once, 4 g of a kitchen detergent was applied, and a grip force by rubbing with both palms was applied, was carried out 50 times.

As a test result, as shown in FIG. 5, it was confirmed that a large amount of bubbles was uniformly generated on the surface and inside of the synthetic resin scouring pad according to the present invention, but a relatively small amount of bubbles was generated and bubbles were locally formed in the steel scouring pad as a control group.

The reason why such a result is generated is that, the coil-shaped film filaments forming the synthetic resin scouring pad manufactured by the present invention have higher elasticity than the metal filaments forming the control group, and thus are compressed and restored as a whole by the grip force during a compression process, and accordingly, it may be determined that the bubble generation performance is superior.

### Cleaning Performance Experiment

First, as shown in FIG. 6, the experimental conditions of the bubble generation performance were as follows: each of a steel scouring pad and an existing net-type synthetic resin scouring pad, a synthetic resin scouring pad of a PET resin and a synthetic resin scouring pad of a PEN resin manufactured by the present invention were impregnated in 1000 ml of tap water at room temperature and dehydrated once, 3 g of a kitchen detergent was applied, and a grip force was applied 10 times to generate bubbles, and then a dirty steel plate requiring washing was cleaned by reciprocating the scouring pads in the order of 10 times, 20 times and 30 times.

As a result, as shown in FIGS. 7A to 7B, it was confirmed that the steel scouring pad and the net-type synthetic resin scouring pad had a cleaning power of 28% and 0.5%, respectively, as a result of 10 times of reciprocating cleaning, and the synthetic resin scouring pads manufactured using a PET resin and a PEN resin by the present invention had a cleaning power of 23.5% and 22% comparable to that of the steel scouring pad.

Further, as results of 20 times and 30 times of reciprocating cleaning, it was confirmed that the synthetic resin scouring pad manufactured by the present invention had an approximate 6 to 17% drop in cleaning performance compared to the steel scouring pad, but had superior cleaning efficiency compared to the existing net-type synthetic resin scouring pad.

Comprehensively, the steel scouring pad is more excellent in terms of cleaning performance, but the synthetic resin scouring pad 100 manufactured by the method of the present invention resolves general problems that the steel scouring pad has, that is, such as problems in which damage to the surface or coating film of object to be cleaned is frequently caused, and metal fine powder formed by grinding of the metal filaments or metal fragments cut from the metal filaments remain on the surface of the object to be cleaned, and thus is determined to be effective enough considering safety or the like and has an advantage in terms of quality.

1. A method of manufacturing a synthetic resin scouring pad, comprising:
a hot extrusion step of extruding a polymer, which is formed by thermally melting a synthetic resin, along a T die having a straight extrusion port, to form a full width film sheet;
a cold curing step of cold-curing the film sheet by impregnating and quenching the extruded full width film sheet with cooling water of a cooling bath;
a cutting step of forming flat film filaments by passing the full width film sheet lengthwise through a cutting part in which cutting blades are arranged at a predetermined width so as to dividingly-cut the full width film sheet into a predetermined width;
a coiling forming step of passing the flat film filaments, formed by the cutting step, in the longitudinal direction through a coiling forming part to plastic-deform the flat film filaments into coil-shaped film filaments; and
an annular winding step of inputting the coil-shaped film filaments into an annular winding part so that the film filaments are wound in an annular shape to form a synthetic resin scouring pad.

2. The method of claim 1, wherein the synthetic resin forming the film sheet and the film filament is formed of any one of a polyethylene terephthalate (PET) resin and a polyethylene naphthalate (PEN) resin.

3. The method of claim 1, wherein the coiling forming part includes: a supply roller part; a discharge roller part; and a coiling guide disposed between the roller parts.

4. The method of claim 1, wherein, in the hot extrusion step, the synthetic resin is mixed with an antibacterial additive and a color additive.
